(19) United States
(12) Patent Application Publication
(10) Pub. No.: US 2024/0067050 A1
(43) Pub. Date: Feb. 29, 2024

(54) CONTROL APPARATUS, NON-TRANSITORY STORAGE MEDIUM, AND OPERATING METHOD FOR CONTROL APPARATUS

(71) Applicant: TOYOTA JIDOSHA KABUSHIKI KAISHA, Toyota-shi (JP)

(72) Inventor: Masashi NAKAMURA, Toyota-shi (JP)

(73) Assignee: TOYOTA JIDOSHA KABUSHIKI KAISHA, Toyota-shi (JP)

(21) Appl. No.: 18/447,946

(22) Filed: Aug. 10, 2023

(30) Foreign Application Priority Data
Aug. 23, 2022 (JP) 2022-132736

(51) Int. Cl. B60L 58/40; B60L 58/30

(52) U.S. Cl. CPC B60L 58/40; B60L 58/30; B60L 2240/14; B60L 2240/26; B60L 2240/642; B60L 2260/52

(57) ABSTRACT

A control apparatus includes a memory configured to store information indicating a first travel amount on a fuel cell and a second travel amount on a battery for a vehicle that runs on the fuel cell and the battery as power sources, and a controller configured to control use of the fuel cell or the battery to increase a proportion of the second travel amount in the first travel amount and the second travel amount overall when an event indicating an overload on the fuel cell occurs.

### CROSS-REFERENCE TO RELATED APPLICATION

This application claims priority to Japanese Patent Application No. 2022-132736, filed on Aug. 23, 2022, the entire contents of which are incorporated herein by reference.

### TECHNICAL FIELD

The present disclosure relates to a control apparatus, a non-transitory storage medium, and an operating method for a control apparatus.

### BACKGROUND

In Fuel Cell Electric Vehicles (FCEVs), which run on fuel cells as their power source, degradation of the fuel cell leads to a decrease in power output, thereby impairing driving performance. Various technologies have thus been proposed to manage the state of fuel cells. For example, Patent Literature (PTL) 1 discloses a vehicle that switches between a fuel cell and a battery as appropriate.

### CITATION LIST

### Patent Literature

PTL 1: JP 2018-143037 A

### SUMMARY

Vehicles that run on a fuel cell and a battery as power sources have room for improvement in the method of switching power sources.

It would be helpful to provide a control apparatus and the like that can improve power source switching in vehicles that run on a fuel cell and a battery as power sources.

A control apparatus in the present disclosure includes:
a memory configured to store information indicating a first travel amount on a fuel cell and a second travel amount on a battery for a vehicle that runs on the fuel cell and the battery as power sources; and
a controller configured to control use of the fuel cell or the battery to increase a proportion of the second travel amount in the first travel amount and the second travel amount overall when an event indicating an overload on the fuel cell occurs.

A program for a control apparatus in the present disclosure is configured to cause the control apparatus to execute operations, the operations including:
deriving a first travel amount on a fuel cell and a second travel amount on a battery for a vehicle that runs on the fuel cell and the battery as power sources; and
controlling use of the fuel cell or the battery to increase a proportion of the second travel amount in the first travel amount and the second travel amount overall when an event indicating an overload on the fuel cell occurs.

An operating method for a control apparatus in the present disclosure includes:
deriving a first travel amount on a fuel cell and a second travel amount on a battery for a vehicle that runs on the fuel cell and the battery as power sources; and
controlling use of the fuel cell or the battery to increase a proportion of the second travel amount in the first travel amount and the second travel amount overall when an event indicating an overload on the fuel cell occurs.

According to the control apparatus and the like in the present disclosure, power source switching can be improved in vehicles that run on a fuel cell and a battery as power sources.

### BRIEF DESCRIPTION OF THE DRAWINGS

In the accompanying drawings:

FIG. 1 is a diagram illustrating an example configuration of a vehicle;

FIG. 2 is a diagram illustrating an example configuration of a control apparatus; and

FIG. 3 is a flowchart illustrating an example of operations of the control apparatus.

### DETAILED DESCRIPTION

Embodiments are described below.

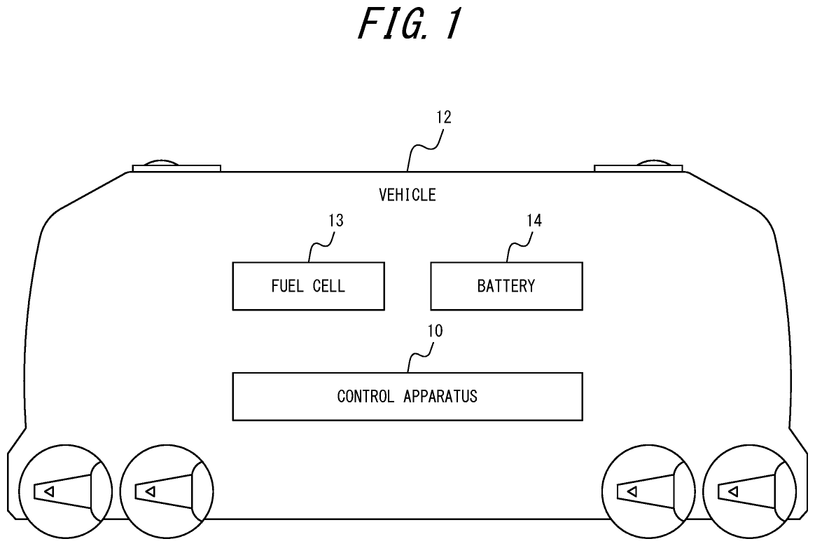

FIG. 1 is a diagram illustrating an example configuration of a vehicle in an embodiment. A control apparatus 10 is an information processing apparatus mounted on a vehicle 12 and controls the operation of the vehicle 12. The vehicle 12 is a passenger car, a bus, a truck, a work vehicle, or the like having a fuel cell 13 and a battery 14 as power sources. The fuel cell 13 generates water and electricity from hydrogen supplied by a hydrogen station or other source and oxygen in the air. The generated electricity is used to drive the vehicle 12. The battery 14 is, for example, a lithium-ion battery. The vehicle 12 is driven manually, but a portion of driving may be automated.

The control apparatus 10 stores a travel history that includes a travel amount on the fuel cell 13 (hereinafter referred to as the fuel cell travel amount) and a travel amount on the battery 14 (hereinafter referred to as the battery travel amount) of the vehicle 12, which runs on the fuel cell 13 and the battery 14 as power sources. Here, the travel amount is the distance traveled or time traveled by the vehicle 12. The control apparatus 10 controls the use of the fuel cell 13 or the battery 14 so as to increase the proportion of the battery travel amount in the fuel cell travel amount and the battery travel amount overall when an event indicating an overload on the fuel cell 13 occurs. In this way, the control apparatus 10 suppresses the use of the fuel cell 13 when an event indicating an overload on the fuel cell 13 occurs, thereby improving power source switching and delaying deterioration of the fuel cell 13.

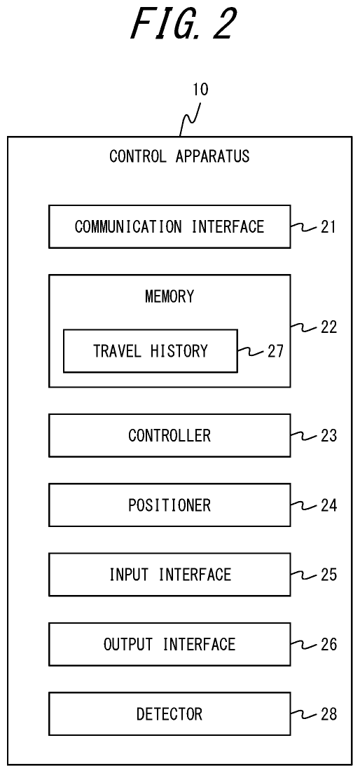

FIG. 2 is a diagram illustrating a configuration example of the control apparatus 10. The control apparatus 10 includes a communication interface 21, a memory 22, a controller 23, a positioner 24, an input interface 25, an output interface 26, and a detector 28. These components may be configured as a single control apparatus, by two or more control apparatuses, or by other apparatuses, such as a control apparatus and a communication device. The control apparatus 10 includes an electronic control unit (ECU), for example. The communication device includes a data communication module (DCM), for example. The control apparatus 10 may be configured to include a personal computer, a tablet terminal, a smartphone terminal, a navigation apparatus, or the like. The components are communicably connected to each other, or to various ECUs or other apparatuses in the vehicle 12, by an in-vehicle network compliant with standards such as a controller area network (CAN). The various ECUs in the vehicle 12 include ECUs that control the fuel cell 13 and the battery 14, respectively.

The communication interface 21 includes one or more interfaces for communication. Examples of the interface for communication include an interface corresponding to mobile communication standards, such as Long Term Evolution (LTE), 4th Generation (4G), or 5th Generation (5G). The communication interface 21 receives information to be used for the operations of the controller 23 and transmits information obtained by the operations of the controller 23. The controller 23 can communicate with other apparatuses through a mobile communication base station using the communication interface 21.

The memory 22 includes, for example, one or more semiconductor memories, one or more magnetic memories, one or more optical memories, or a combination of at least two of these types, to function as main memory, auxiliary memory, or cache memory. The semiconductor memory is, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 22 stores information to be used for the operations of the controller 23 and information obtained by the operations of the controller 23. The memory 22 stores the travel history 27. The travel history 27 includes the fuel cell travel amount and battery travel amount for the vehicle 12.

The controller 23 includes one or more processors, one or more dedicated circuits, or a combination thereof. The processor is a general purpose processor, such as a central processing unit (CPU), or a dedicated processor, such as a graphics processing unit (GPU), specialized for a particular process. The dedicated circuit is, for example, a field-programmable gate array (FPGA), an application specific integrated circuit (ASIC), or the like. The controller 23 executes information processing related to operations of the control apparatus 10 while controlling components of the control apparatus 10. The controller 23 receives information from the control ECUs of the fuel cell 13 and the battery 14 indicating the state of charging and discharging of the fuel cell 13 and the battery 14 and transmits instructions for control.

The positioner 24 includes one or more Global Navigation Satellite System (GNSS) receivers. The GNSS includes, for example, at least one of Global Positioning System (GPS), Quasi-Zenith Satellite System (QZSS), BeiDou, Global Navigation Satellite System (GLONASS), and Galileo. The positioner 24 acquires the positional information for the vehicle 12 and transmits the positional information to the controller 23.

The input interface 25 includes one or more interfaces for input. The interface for input is, for example, a physical key, a capacitive key, a pointing device, a touch screen integrally provided with a display, or a microphone that receives audio input. The input interface 25 accepts operations for inputting information to be used in the operations of the control apparatus 10 and transmits the inputted information to the controller 23.

The output interface 26 includes one or more interfaces for output. The interface for output is, for example, a display or a speaker. The display is, for example, a Liquid Crystal Display (LCD) or an organic Electro Luminescent (EL) display. The output interface 26 outputs information obtained by the operations of the control apparatus 10.

The detector 28 includes one or more sensors, or interfaces with sensors, that detect the condition or operation of various components in the vehicle 12 and transmits information indicating the results of detection by the sensors to the controller 23. The sensors detect vehicle speed, acceleration, inclination of the vehicle body, weight of the vehicle body including load, current and voltage of the fuel cell 13 and the battery 14, and the like.

The functions of the controller 23 are realized by a processor included in the controller 23 executing a control program. The control program is a program for causing a computer to execute the processing of steps included in operations of the controller 23, thereby enabling the computer to realize the functions corresponding to the processing of the steps. That is, the control program is a program for causing a computer to function as the controller 23. Some or all of the functions of the controller 23 may be realized by a dedicated circuit included in the controller 23.

The controller 23 generates information for control of various mechanisms and apparatuses of the vehicle 12 and transmits the information for control to the control circuits of the various mechanisms and apparatuses to control the mechanisms and apparatuses. The controller 23 may support driving operations by controlling mechanisms that accept driving operations.

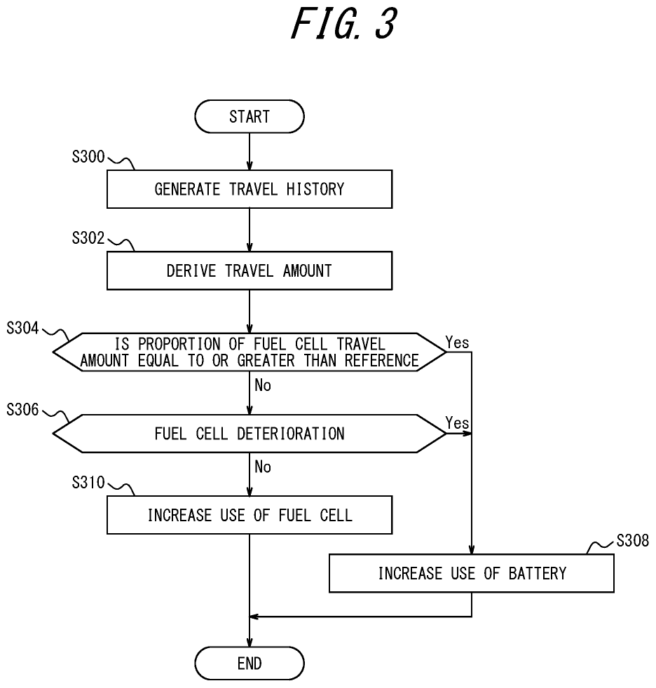

FIG. 3 is a flowchart illustrating the operating procedures by the controller 23 of the control apparatus 10 in the present embodiment. The procedures in FIG. 3 are performed in any appropriate cycles, for example, from several milliseconds to ten and some seconds.

In step S300, the controller 23 generates the travel history 27 for the vehicle 12. The travel history 27 includes a travel route and time traveled. The controller 23 derives the travel route and time traveled by the vehicle 12 using the map information stored in advance in the memory 22 and the change over time in positional information acquired by the positioner 24. The controller 23 derives the travel route and time traveled when using the fuel cell 13 and the battery 14, respectively. In a case in which the travel history 27 has already been generated, information on the difference is added and the travel history 27 is updated.

In step S302, the controller 23 derives the travel amount of the vehicle 12. The travel amount is the distance traveled, the time traveled, or a value obtained by scoring these using any appropriate algorithm. For example, the controller 23 may weight the distance traveled by the time traveled to obtain a score indicating the travel amount. Furthermore, the controller 23 may weight the travel amount according to factors such as the amount of acceleration/deceleration, the uphill/downhill angle, or the weight of passengers or cargo during travel. For example, as the amount of acceleration/deceleration, the uphill/downhill angle, or the weight is greater, the travel amount is multiplied by a larger weight factor. The weight based on the amount of acceleration/deceleration, the uphill/downhill angle, or the weight is normalized to an appropriate scale. The controller 23 derives the amount of acceleration/deceleration, the uphill/downhill angle, the weight of the vehicle, and the like based on information from the detector 28. The controller 23 derives the fuel cell travel amount when the fuel cell 13 is used and the battery travel amount when the battery 14 is used, respectively. The derived travel amounts are stored in the memory 22 as part of the travel history 27.

Next, the controller 23 determines whether an event indicating an overload on the fuel cell 13 has occurred.

In step S304, the controller 23 determines whether the proportion of the fuel cell travel amount in the total amount of the fuel cell travel amount and the battery travel amount overall is equal to or greater than a reference. The reference is set in advance to any value equal to or greater than 40% to 50%, for example. If the proportion is equal to or greater than the reference (Yes), the controller 23 advances to step S308, whereas if the proportion is less than the reference (No), the controller 23 advances to step S306.

In step S306, the controller 23 determines the deterioration of the fuel cell 13. The controller 23 derives the current-voltage characteristics of the fuel cell 13 using information from the detector 28 and determines that the fuel cell 13 has deteriorated in a case in which the current-voltage characteristics fall below a freely set reference. If deterioration is determined (Yes), the controller 23 advances to step S308, whereas if deterioration is not determined (No), the controller 23 advances to step S310.

In a case in which the proportion of the fuel cell travel amount is equal to or greater than the reference, or the fuel cell 13 has deteriorated, the controller 23 controls the output of the power sources in step S308 so as to increase use of the battery 14. For example, the controller 23 switches to using the battery 14 the case of traveling using the fuel cell 13 and maintains use of the battery 14 in the case of travelling using the battery 14.

Conversely, in a case in which the proportion of the fuel cell travel amount is less than the reference and the fuel cell 13 has not deteriorated, the controller 23 controls the output of the power sources in step S310 so as to increase use of the fuel cell 13. For example, the controller 23 switches to use of the fuel cell 13 in the case of traveling using the battery 14 and maintains use of the fuel cell 13 in the case of traveling using the fuel cell 13.

After step S308 or S310, the controller 23 completes this cycle. The controller 23 repeats the procedures in FIG. 3 cyclically.

The operations described above enable the control apparatus 10 to reduce the deterioration rate of the fuel cell 13 by keeping the fuel cell travel amount constant. When the travel amount is derived, the load on the fuel cell can be more accurately reflected in the travel amount by the travel amount being weighed according to factors such as the amount of acceleration/deceleration, the uphill/downhill angle, or the weight of passengers or cargo during travel. Such operations enable the control apparatus 10 to improve power source switching and delay the deterioration of the fuel cell 13. Furthermore, by the deterioration of the fuel cell 13 being delayed, the resale price of the vehicle 12 can be maintained at a higher level, or the lease term of the vehicle 12 or the fuel cell 13 can be extended.

A case in which the control apparatus 10 is mounted on the vehicle 12 has been described above as an example. However, the vehicle 12 may, for example, communicate with a server apparatus via mobile communication, and the operations of the present embodiment may be executed by the server apparatus or jointly by the server apparatus and the control apparatus 10 on the vehicle 12 side. In such a case, the server apparatus or the server apparatus and the control apparatus 10 on the vehicle 12 side correspond to the control apparatus of the present embodiment.

The program that defines the operations of the control apparatus 10 may, for example, be acquired by the control apparatus 10 by downloading from a server or the like and may be stored in the memory 22.

While embodiments have been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

Examples of some embodiments of the present disclosure are described below. However, it should be noted that the embodiments of the present disclosure are not limited to these examples.

[Appendix 1] A control apparatus comprising:
a memory configured to store information indicating a first travel amount on a fuel cell and a second travel amount on a battery for a vehicle that runs on the fuel cell and the battery as power sources; and
a controller configured to control use of the fuel cell or the battery to increase a proportion of the second travel amount in the first travel amount and the second travel amount overall when an event indicating an overload on the fuel cell occurs.
   [Appendix 2] The control apparatus according to appendix 1, wherein the controller is configured to weight the first travel amount according to an amount of acceleration/deceleration, an uphill/downhill angle, or a load in the vehicle during use of the fuel cell.
   [Appendix 3] The control apparatus according to appendix 1 or 2, wherein the event includes a case in which a proportion of the first travel amount in the first travel amount and the second travel amount overall is equal to or greater than a reference.
   [Appendix 4] The control apparatus according to any one of appendices 1 to 3, wherein the event includes a case in which the fuel cell exhibits a predetermined state of deterioration.
   [Appendix 5] A program for a control apparatus, the program being configured to cause the control apparatus to execute operations, the operations comprising:
deriving a first travel amount on a fuel cell and a second travel amount on a battery for a vehicle that runs on the fuel cell and the battery as power sources; and
controlling use of the fuel cell or the battery to increase a proportion of the second travel amount in the first travel amount and the second travel amount overall when an event indicating an overload on the fuel cell occurs.
   [Appendix 6] The program according to appendix 5, wherein the operations further comprise weighting the first travel amount according to an amount of acceleration/deceleration, an uphill/downhill angle, or a load in the vehicle during use of the fuel cell.
   [Appendix 7] The program according to appendix 5 or 6, wherein the event includes a case in which a proportion of the first travel amount in the first travel amount and the second travel amount overall is equal to or greater than a reference.
   [Appendix 8] The program according to any one of appendices 5 to 7, wherein the event includes a case in which the fuel cell exhibits a predetermined state of deterioration.
   [Appendix 9] An operating method for a control apparatus, the operating method comprising:
deriving a first travel amount on a fuel cell and a second travel amount on a battery for a vehicle that runs on the fuel cell and the battery as power sources; and
controlling use of the fuel cell or the battery to increase a proportion of the second travel amount in the first travel amount and the second travel amount overall when an event indicating an overload on the fuel cell occurs.
   [Appendix 10] The operating method according to appendix 9, further comprising weighting the first travel amount according to an amount of acceleration/deceleration, an uphill/downhill angle, or a load in the vehicle during use of the fuel cell.
   [Appendix 11] The operating method according to appendix 9 or 10, wherein the event includes a case in which a proportion of the first travel amount in the first travel amount and the second travel amount overall is equal to or greater than a reference.
   [Appendix 12] The operating method according to any one of appendices 9 to 11, wherein the event includes a case in which the fuel cell exhibits a predetermined state of deterioration.

1. A control apparatus comprising:
a memory configured to store information indicating a first travel amount on a fuel cell and a second travel amount on a battery for a vehicle that runs on the fuel cell and the battery as power sources; and
a controller configured to control use of the fuel cell or the battery to increase a proportion of the second travel amount in the first travel amount and the second travel amount overall when an event indicating an overload on the fuel cell occurs.

2. The control apparatus according to claim 1, wherein the controller is configured to weight the first travel amount according to an amount of acceleration/deceleration, an uphill/downhill angle, or a load in the vehicle during use of the fuel cell.

3. The control apparatus according to claim 1, wherein the event includes a case in which a proportion of the first travel amount in the first travel amount and the second travel amount overall is equal to or greater than a reference.

4. The control apparatus according to claim 1, wherein the event includes a case in which the fuel cell exhibits a predetermined state of deterioration.

5. A non-transitory storage medium storing a program for a control apparatus, the program configured to cause the control apparatus to execute operations, the operations comprising:
deriving a first travel amount on a fuel cell and a second travel amount on a battery for a vehicle that runs on the fuel cell and the battery as power sources; and
controlling use of the fuel cell or the battery to increase a proportion of the second travel amount in the first travel amount and the second travel amount overall when an event indicating an overload on the fuel cell occurs.

6. The non-transitory storage medium according to claim 5, wherein the operations further comprise weighting the first travel amount according to an amount of acceleration/deceleration, an uphill/downhill angle, or a load in the vehicle during use of the fuel cell.

7. The non-transitory storage medium according to claim 5, wherein the event includes a case in which a proportion of the first travel amount in the first travel amount and the second travel amount overall is equal to or greater than a reference.

8. The non-transitory storage medium according to claim 5, wherein the event includes a case in which the fuel cell exhibits a predetermined state of deterioration.

9. An operating method for a control apparatus, the operating method comprising:
deriving a first travel amount on a fuel cell and a second travel amount on a battery for a vehicle that runs on the fuel cell and the battery as power sources; and
controlling use of the fuel cell or the battery to increase a proportion of the second travel amount in the first travel amount and the second travel amount overall when an event indicating an overload on the fuel cell occurs.

10. The operating method according to claim 9, further comprising weighting the first travel amount according to an amount of acceleration/deceleration, an uphill/downhill angle, or a load in the vehicle during use of the fuel cell.

11. The operating method according to claim 9, wherein the event includes a case in which a proportion of the first travel amount in the first travel amount and the second travel amount overall is equal to or greater than a reference.

12. The operating method according to claim 9, wherein the event includes a case in which the fuel cell exhibits a predetermined state of deterioration.
